(19) United States
(12) Patent Application Publication
(10) Pub. No.: US 2007/0023592 A1
(43) Pub. Date: Feb. 1, 2007

(54) Apparatus to support a window air conditioning unit, and method for installation

(76) Inventor: Bernardo Makoso, New York, NY (US)

Correspondence Address: RAYMOND F. MIGNOGNA, 612 GATEWAY, VALLEY COTTAGE, NY, 10989, US

(21) Appl. No.: 11/493,184

(22) Filed: Jul. 26, 2006

Related U.S. Application Data
(60) Provisional application No. 60/702,598, filed on Jul. 27, 2005.

(51) Int. Cl. E06B 7/02; E04G 25/00

(52) U.S. Cl. 248/200.1; 454/196

(57) ABSTRACT

An improved device for mounting and support of window air conditioning units is disclosed along with a method of installation. The device consists of two support assemblies, one located directly beneath, and another, directly above, an air conditioning unit. The lower support assembly also has additional legs that bear on the external window sill, thus providing additional load bearing capacity for the lower assembly. Each of the assemblies is anchored to the interior side of the window frame via tabs located at the ends of each assembly, and secured with self-tapping screws. Two or more vertical rod assemblies anchor the lower and upper support assemblies to each other, and provide additional support to keep the air conditioning unit from pivoting and falling out of the window, as well as serving to resist loosening due to vibration encountered during operation of the air conditioner.

### CROSS-REFERENCES

Provisional Patent Application 60/702,598; Filed 27 Jul. 2005, and incorporated by reference.

### BACKGROUND

1. Field of the Invention

The present invention relates to the installation of window mounted air conditioners generally, and more specifically, to novel mounting support systems for such air conditioners which are simple, safe and can be adapted to accommodate varying sizes and weights of air conditioners while permitting the windows to opened and cleaned without disturbing the installation or endangering the user.

2. Description of Related Art

Window air conditioners are widely used for cooling selected rooms or portions of buildings. While these air conditioners are generally sold without mounting hardware or instructions, methods of mounting these air conditioners are well known in the prior art.

As window air conditioning units are self-contained, including electric motors and compressors, they can be quite heavy and difficult to mount within window frames. Additionally, such units do not fit precisely into a variety of industry standard window frames. Information relevant to addressing these mounting and supporting problems and be found in U.S. Pat. No. 6,767,278 issued Jul. 27, 2004, to Peterson, which discloses an air conditioner installation system; U.S. Pat. No. 3,476,033 issued Nov. 4, 1969 to Appel, which discloses a room air conditioner improved mounting arrangement; U.S. Pat. No. 3,911,803 issued Oct. 14, 1975 to Kong et al, which also discloses a mounting arrangement for a room air conditioner; and U.S. Pat. No. 5,636,816 issued Jun. 10, 1997 to Burton, et al, which discloses a universal air conditioner mounting bracket and method.

While these devices fulfill their own particular objectives and requirements, there is a need for a mounting device and system with improved safety features that is both easy to install, safe and provides a secure locking mechanism to insure that the system will not loosen over time. In addition, there is a need to mount such units in a manner that will adequately secure or support air conditioners so as to prevent them from becoming loosened over time due to excess operational vibration, and thus posing an unintended potential safety hazard to the users. These improved safety features are at the heart of the present invention.

### SUMMARY OF THE INVENTION

In view of the aforementioned disadvantages inherent in the known types of window mounted air conditioner installation systems present in the prior art, the present invention proposes an improved window mounted air conditioner system which has all of the advantages inherent in the prior art while overcoming the disadvantages previously noted.

In particular, the present system provides a support method utilizing the external window sill as a bearing surface to provide additional support for the weight of the air conditioner unit. This is especially significant in that the operation of such units occurs via an internal motor, which vibrates during said operation, and therefore has a natural tendency to loosen the entire unit when mounted within the window frame. In particular, any mounting method that relies on frictional forces to hold an air conditioning unit in place may be subject to loosening due to such vibration. The present invention minimizes the impact of said vibration due to the inherent damping provided by the additional bearing points, as can be seen in FIG. 3 of the drawings.

Additionally, the method of securing the bracket assemblies and the air conditioning unit in place is enhanced by the use of a series of safety anchors, which serve to tie together the top and bottom bracket assemblies. These safety anchors, which each consist of a tensioning bolt system, are shown in FIG. 6. The threads of each bolt may be coated with an air hardening epoxy (Ref. Number 8 of FIG. 6) to provide additional mechanical strength, and to further reduce the tendency of vibration to loosen the mounting system.

Mounting flexibility is provided through the use of multi-component sliding assemblies which can be adjusted to fit in any standard or custom sized window opening, and anchored in place using a variety of mounting methods, including self-tapping screws, bolts or clips. Such mounting will prevent the sliding components from shifting once they have been installed within the window frame opening.

Air conditioner units are mounted on a bottom assembly, consisting of three interleaved components which have been secured in place before placing the air conditioner unit. A similar arrangement of a top assembly is mounted on the upper surface of the air conditioner, and secured in place in a similar manner. The contact surfaces of each of these assemblies may be coated so as to prevent damage to the finish of the air conditioning unit. The coating may be applied by painting or spraying, or any other suitable method, and may consist of any non-stick substance.

While the construction of the bottom and top assemblies is envisioned to be of metal, these components can be made of any suitable material having sufficient strength to support the weight of the air conditioner to be installed

### BRIEF DESCRIPTION OF THE DRAWINGS

A clear understanding of the invention will become apparent from the following detailed description, which makes reference to the attached drawings where:

FIG. 1 shows an isometric view of an embodiment of the invention, as seen from the inside of the window;

FIG. 2 shows a front view of an embodiment of the invention, as seen from the inside of the window;

FIG. 3 shows a section view of an embodiment of the invention, taken along the line X-X of FIG. 2;

FIG. 4 shows an isometric view of the entire Bottom Assembly;

FIG. 5 shows an isometric view of the entire Top Assembly;

FIG. 6 shows the safety anchoring bolts and their method of attachment; and

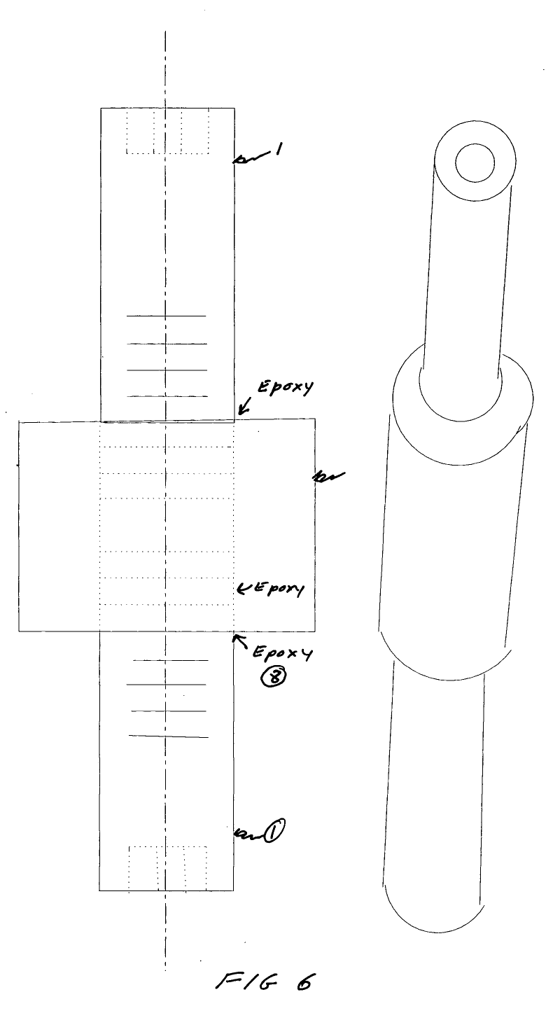

FIG. 7 shows the positioning of the safety anchoring bolts within the entire bracket assembly.

### DESCRIPTION

Now, referring to the drawings, the improved window air conditioner mounting components and method of installation will be described.

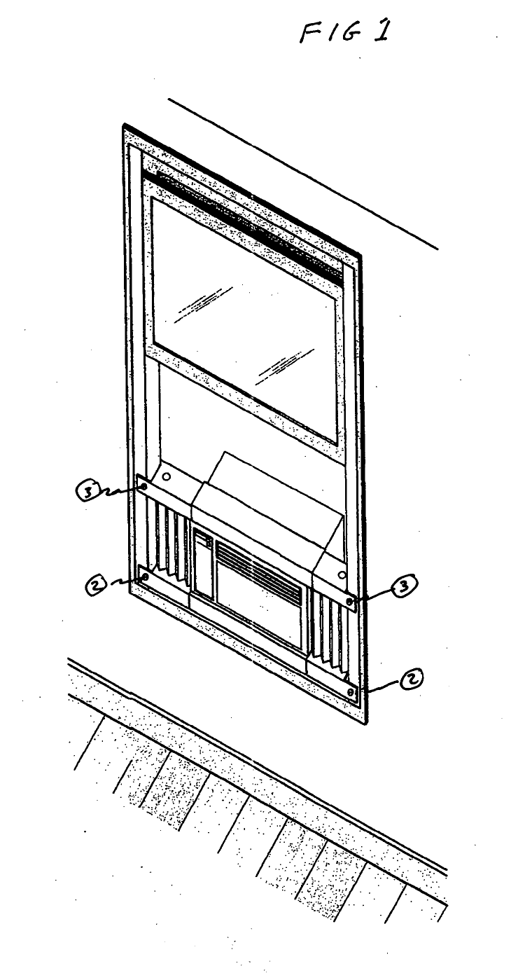

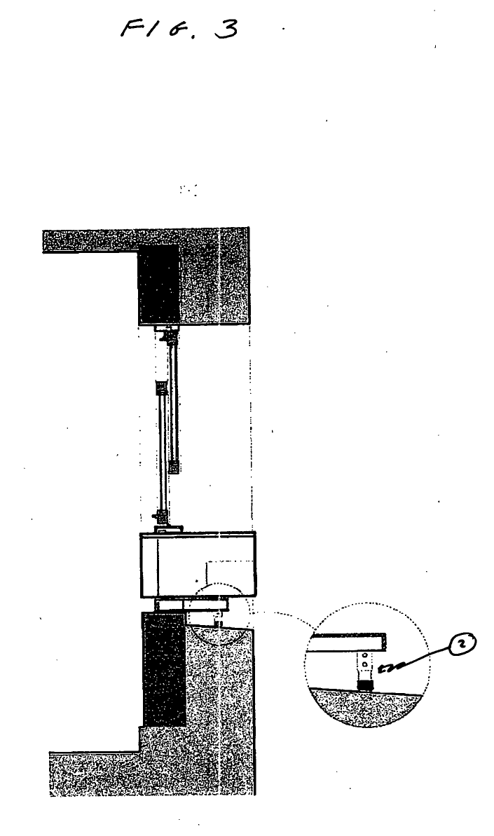

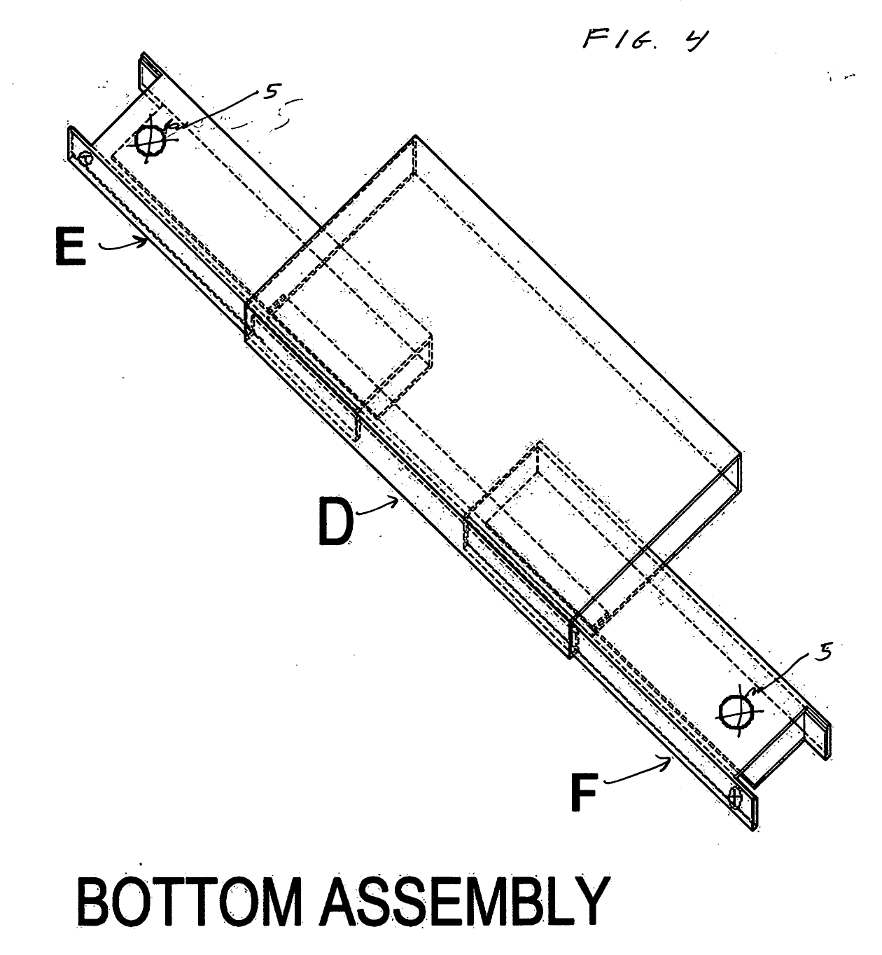

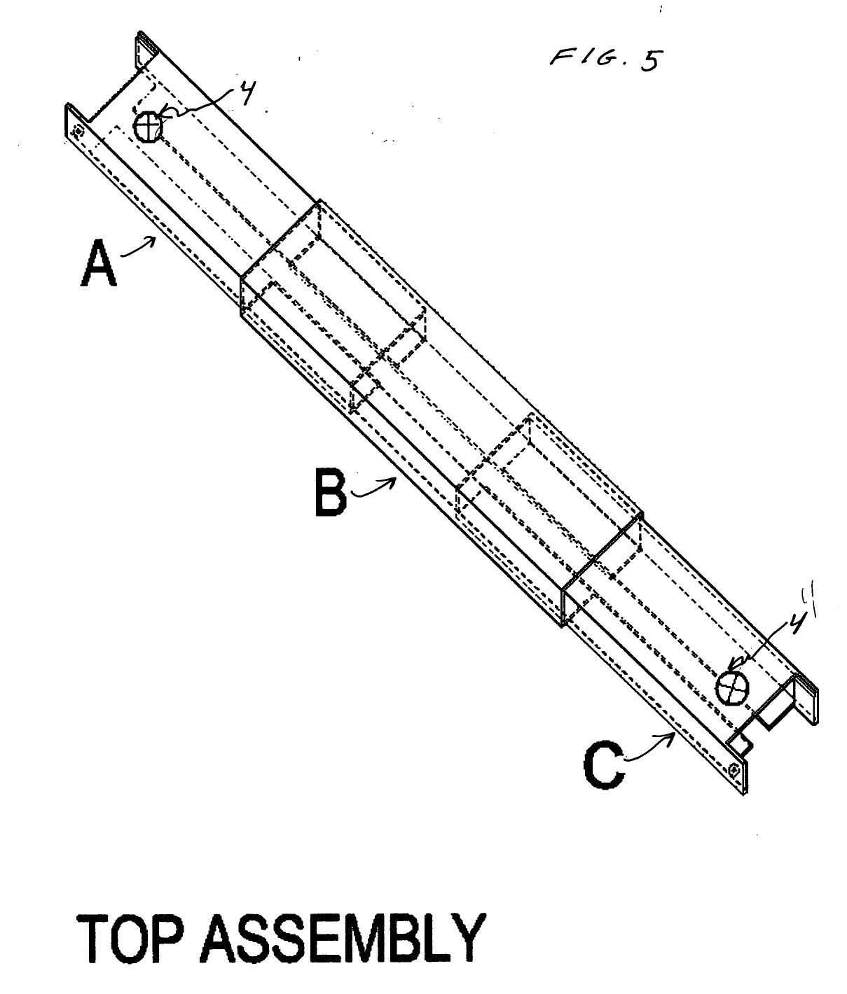

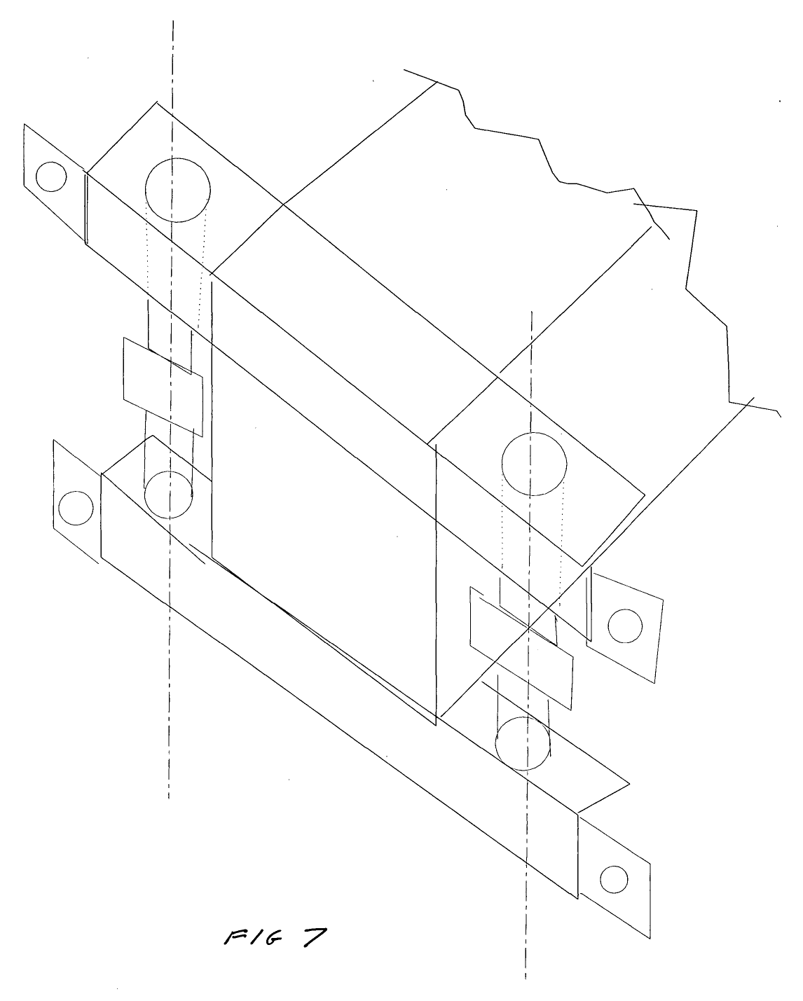

The components of the mounting system comprises a bottom support assembly, which consists of three pieces as shown in FIG. 4; a top support assembly, which consists of three pieces as shown in FIG. 5; adjustable support legs as shown in FIG. 3; vertical support rod assemblies as shown in FIG. 7, and a plurality of screws (Ref. Numbers 2 and 3 of FIG. 1).

Each of the aforementioned components and assemblies are envisioned as being made out of metal, preferably steel or aluminum, but may be made out of any other material having sufficient strength to withstand the forces encountered during installation and operation of the air conditioner. In addition, each of the support legs will have a elastomer or rubber cushion attached to its lower end, which will rest upon the outside lower window sill.

The support unit is installed in an integral manner with the air conditioner, as described below.

First, a plurality of adjustable height metallic legs (Reference Numeral 2 of FIG. 3) are secured to the center piece of the bottom bracket assembly by means of (part D of FIG. 4).

While two such legs are envisioned in a preferred embodiment, any number of such legs may be used depending on the weight of the air conditioner unit being supported. Secondly, the bottom safety bolts are installed by passing them upwards through pieces E and F of FIG. 4 through holes 5 drilled or punched in bottom assembly pieces E and F, shown in FIG. 4. While two such bolts, one for each of pieces E and F, are envisioned, more can be used if the air conditioner unit is particularly large or prone to excessive vibration. Then, the entire bottom assembly, with legs attached, and consisting of parts D, E, and F as shown on FIG. 4 is positioned on the bottom of the window sill and is secured in place by mounting screws through assembly pieces E and F. to the internal side of the window frame using screws 2 in FIG. 1. While at least one such screw is required per assembly piece, more may be used if additional support is necessary.

The next step is to coat the external threads of the bottom safety bolts with an air drying epoxy, and then threading the center sections onto the bottom of each bolt, such that at least one inch of total thread engagement is achieved, and, ideally, such that the center sections are positioned in the vertical center of the mounting system, as shown in FIG. 7.

The air conditioner is then moved into position by placing it atop the bottom assembly, and then having the top bracket assembly placed directly atop it, and anchoring top assembly brackets A and C to the inside of the window frame using screws 3 in FIG. 1. Again, as with the bottom assembly, more than one screw per assembly bracket may be required depending upon the weight being held in place.

Lastly, the top safety bolts are coated with epoxy and threaded into the center sections on each side of the assembly by passing them through drilled or punched holes 4 in top assembly pieces A and C. shown in FIG. 5. The bolts are now secured in place using an appropriate hex headed key and tightened to secure the entire assembly in place. The key is then removed so as to prevent inadvertent loosening of the safety assembly, and the air conditioner is now ready for operation. The windows themselves can now slide freely within their tracks, as shown in FIG. 1 and FIG. 3, without any need to disturb the mounting system or the air conditioner.

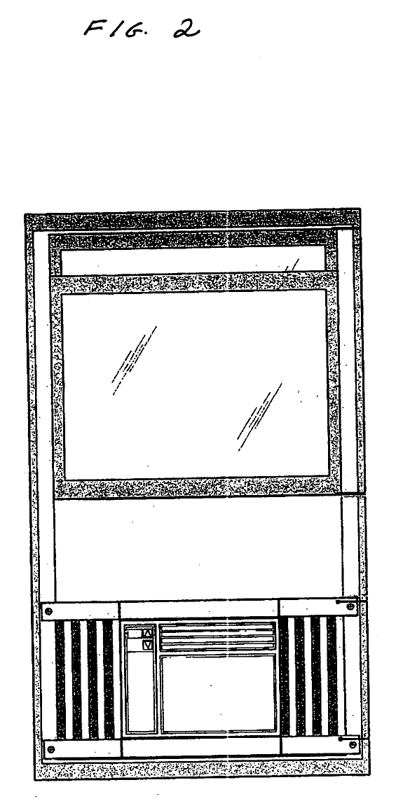

In addition, the side vanes usually supplied with such air conditioner units can be adjusted horizontally if desired to permit or close off additional air flow into the room. FIGS. 1 and 2 show the side vanes in a fully deployed configuration.

What is claimed is:

1- An apparatus for holding and supporting an air conditioner securely in place within a window opening and a method of securing same, while allowing the window to be opened or closed without disturbing the air conditioner, comprised of the following:
a) a bottom assembly section, constructed of formed sheet metal bent into the shape of a channel, which rests on the lower horizontal frame of said window and outer sill of the window frame, including a first piece having a length of at least 50% but no more than 80% of the length of said sash, a second piece also constructed of formed sheet metal bent to match said first piece while also nesting within said first piece, and having a length of at least 30% but no more than 50% of the length of said horizontal frame , a third piece also constructed of formed sheet metal bent to match said first piece while also nesting within said first piece, also having a length of at least 30% but no more than 50% of said horizontal frame, with both the second piece and the third piece having vertical tabs which nest on both the external and internal sides of the vertical frame of said window;
b) a top assembly section, constructed of formed sheet metal bent into a channel into which the lower horizontal sash of the outer portion of a vertically reciprocal rectangular window, including a first piece having a length of at least 50% but no more than 80% of the length of said lower section, a second piece also constructed of formed sheet metal bent to match said first piece and nesting within it, and having a length of at least 30% but no more than 50% of said lower sill, a third piece also constructed of formed sheet metal bent to match said first piece and nesting within it, and having a length of at least 30% but no more than 50% of said lower sill, with both the second piece and the third piece having vertical tabs which nest on both the external and internal sides of the vertical frame of said window;
c) two vertically mounted round rod assemblies, each consisting of a lower rod having a hexagonal recess cut in the bottom of said rod and having external screw threads on the top of said rod having a total thread length equal to at least 50% of the total length of said rod, an upper rod having a hexagonal recess cut in the top of said rod and having external screw threads on the bottom of said rod having a total thread length equal to at least 50% of the total length of said rod, and a center rod, being hollow through it's entire length, and having internal screw threads beginning at each end and extending into said rod for at least 30% but not greater than 50% of it's length, wherein each lower rod is inserted through a suitably sized hole provided in the second and third pieces of the lower assembly section, and each upper rod is inserted through a suitably sized hole provided in the second and third piece of the upper assembly section, and the center piece of each rod is situated between the upper and lower rods so that the threaded sections of the upper and lower rods are threaded into the mating threads of the center rod, the diameter of each lower and upper rod being between one quarter and less than one half of the thickness of the window frame, and the outer diameter of the center rods being no greater than the thickness of the side of the window frame.

2- An apparatus as described in claim 1, having a plurality of vertically placed rotatably adjustable legs, with each leg being mounted to the underside of the first piece of the bottom assembly section, with the lower end resting on the lower external sill of said window.

3- An apparatus as described in claim 1, having a plurality of mounting holes located within each tab on piece two and piece three of the lower assembly section, and piece two and piece three of the upper assembly section.

4- An apparatus as described in claim 1 having a plurality of holes drilled into the top of the second piece and the top of the third piece of the bottom assembly section, and into the bottom of the second piece and the bottom of the third piece of the top assembly section, with the diameter of each of said drilled holes being greater than the diameter of the rods described in claim 1, but less than one half of the thickness of the window pane frame.

5- A method of attachment of the apparatus described in claim 1 to a window frame using a plurality of screws passing through the tabs of each of the second and third pieces of the bottom and top assemblies of said apparatus, and being anchored within said window frame.

6- A method of securing an air conditioning unit to the apparatus of claim 1 by placing said unit on the bottom assembly, and placing the top assembly upon the air conditioning unit, and securing the top and bottom assemblies of the apparatus together by passing an upper threaded rod through the second piece of the top assembly, and passing a lower threaded rod through the second piece of the bottom assembly, and inserting a center rod between them such that the threaded ends of both the upper and lower rods rotationally engage the internal threads of said center rod, and passing an upper threaded rod through the third piece of the top assembly, and passing a lower threaded rod through the third piece of the bottom assembly, and inserting a center rod between them such that the threaded ends of both the upper and lower rods rotationally engage the internal threads of the center rod, and securing each of said rod assemblies in place by inserting a matching hexagonal head key into each of the hexagonal recesses cut into the upper and lower rods respectively, and rotationally engaging the rods using a clockwise rotation until each rod assembly has been tightened sufficiently to secure the air conditioning unit to prevent it's movement within said apparatus.
